(19) United States
(12) Patent Application Publication
(10) Pub. No.: US 2022/0344096 A1
(43) Pub. Date: Oct. 27, 2022

(54) METHOD FOR PREPARING HIGH-PERFORMANCE ANISOTROPIC RARE-EARTH-FREE PERMANENT MAGNETS

(71) Applicant: China Jiliang University, Zhejiang (CN)

(72) Inventors: Qiong WU, Zhejiang (CN); Yuanhao TU, Zhejiang (CN); Minxiang PAN, Zhejiang (CN); Hongliang GE, Zhejiang (CN)

(73) Assignee: China Jiliang University, Zhejiang (CN)

(21) Appl. No.: 17/537,487

(22) Filed: Nov. 30, 2021

(30) Foreign Application Priority Data
Apr. 22, 2021 (CN) 202110436941.X

(51) Int. Cl. H01F 41/02; B22F 9/04; C22C 22/00; H01F 1/047

(52) U.S. Cl. CPC H01F 41/0253; B22F 9/04; C22C 22/00; H01F 1/047; B22F 2009/043; C22C 2202/02; B22F 2202/05

(57) ABSTRACT

The present invention discloses a method for preparing high-performance anisotropic rare-earth-free permanent magnets, comprising the steps of: forming alloy ingots by melting according to a nominal composition of MnₓBi₁₀₀₋ₓ, (45≤×≤55); then coarsely crushing the alloy ingots and passing the crushed material through a 100-mesh sieve to obtain coarse powder; putting an appropriate amount of MnₓBi₁₀₀₋ₓ alloy coarse powder obtained into a ball-milling tank together with non-magnetic steel balls, with a ratio of ball to powder of 10:1; adding an appropriate amount of ethanol as solvent, and then adding a non-ionic surfactant polyvinylpyrrolidone (PVP) accounting for 5-15% of the power mass to assist in low-energy ball milling; washing the slurry obtained in anhydrous ethyl alcohol, and orientating and curing the washed magnetic powder in a magnetic field after adding binder to obtain high-performance anisotropic Mn—Bi alloy magnets finally.

### CROSS-REFERENCE TO RELATED APPLICATION

This application claims the priority benefit of China application No. 202110436941.X, filed on Apr. 22, 2021. The entirety of the above-mentioned patent application is hereby incorporated by reference herein and made a part of this specification.

### BACKGROUND

### Technical Field

This present intention relates to a method for preparing high-performance anisotropic rare-earth-free permanent magnets, especially obtained by surfactant-assisted low-energy ball milling. It belongs to the field of material science and technology.

### Description of Related Art

The fast-evolving science and technology raise more stringent requirements for all kinds of materials under different extreme environmental conditions, especially in automobile, aerospace, and other fields. Permanent magnets, as the most important function material, are becoming more and more widely used in the fields of national economy and science and technology. At present, Nd—Fe—B rare-earth permanent magnets receive great attention due to superior performance. However, since a Curie temperature of Nd—Fe—B rare-earth permanent magnets is only 318° C., a working temperature is mostly lower than 100° C. MnBi permanent magnetic alloys have been studied and concerned extensively as they can reach a Curie temperature of 450° C., have a positive temperature coefficient of coercivity with an intrinsic coercivity of up to 25.8 kOe at 280° C. (especially applicable to the high-temperature environment), and contain no rare earth elements of high price. Low-energy ball milling is now used as an effective process to produce MnBi alloy powder. Mechanical ball milling refines grains of a MnBi low-temperature phase (LTP-MnBi), thereby enhancing the intrinsic coercivity. However, the LTP-MnBi of the MnBi alloys may partially decompose during the ball milling due to too high mechanical energy; the longer the ball milling time, the more serious the decomposition. This directly affects its saturation magnetization, so that it is of vital importance to inhibit the decomposition of the LTP-MnBi phase during ball milling.

### SUMMARY

To solve the above-mentioned technical problems in the prior art, this present intention proposes a method for preparing high-performance anisotropic MnBi alloy magnets by surfactant-assisted low-energy ball milling. During the ball milling, high-strength collisions occur between MnBi alloys and non-magnetic steel balls, so the addition of surfactant plays an important role in the ball milling process. During the ball grinding, particles of superfine powder tend to gather together and automatically reduce the surface energy due to its large specific surface area and specific surface energy. Based on the DLVO theory and the steric stabilization theory, a surfactant is added to the ball milling medium and adsorbed on the particle surface, thereby reducing the surface energy of the system; meanwhile, adsorption leads to the identical charges on the particle surfaces, thereby serving for electrostatic repulsion between particles to prevent agglomeration from occurring. The addition of surfactant may change the rheological properties of the material slurry, reduce the viscosity of the material slurry, and keep the ball mill at a high ball milling efficiency, thereby reducing the particle size of ball-milled materials and improving the fine fraction content in the product. Moreover, a thick adsorption layer formed by some polymer long-chain surfactants on the powder surface may also play a steric stabilization role; the thick adsorption layer produces a new repulsive potential energy, i.e., steric repulsion potential energy, thereby preventing the secondary agglomeration of superfine powder and improving the dispersion of superfine powder in the ball milling medium. Polyvinylpyrrolidone (PVP) is a non-ionic water-soluble long-chain polymer compound, polymerized by N-vinyl pyrrolidone under certain conditions, with many superior physicochemical properties, easily soluble in ethanol, safe and non-toxic; may mutually dissolve or compound with a variety of high and low molecular substances; has an excellent adsorption, film-forming property, adhesion, and good thermal stability. In the PVP structure, methylene forming a PVP chain as well as located on a pyrrolidone ring are a non-polar group, while lactam in lipophilic molecules is a strongly polar group, playing a role of hydrophilic and polar groups.

The present invention is intended to provide a method for preparing high-performance anisotropic MnBi alloy magnets by surfactant-assisted low-energy ball milling.

The present invention is intended to provide a method for preparing high-performance anisotropic MnBi alloy power by surfactant-assisted low-energy ball milling, comprising the steps of:

1) Proportioning: Mn and Bi alloys with a purity of over 99.99% are weighed and proportioned according to a nominal composition of MnₓBi₁₀₀₋ₓ, (45≤×≤55);

2) Melting: The proportioned raw materials are placed into an electric arc furnace under argon protection to obtain MnₓBi₁₀₀₋ₓ alloy ingots by using an arc-melting method;

3) Coarse crushing: The MnₓBi₁₀₀₋ₓ alloy ingots obtained in step 2) are coarsely crushed and passed through a 100-mesh sieve to obtain coarse powder;

4) Proportioning in a ball milling tank: An appropriate amount of MnₓBi₁₀₀₋ₓ, alloy coarse powder obtained in step 3) is put into a ball milling tank together with non-magnetic steel balls, with a ratio of ball to powder of 10:1; an appropriate amount of ethanol is added as solvent, and a non-ionic surfactant polyvinylpyrrolidone (PVP) accounting for 10-50% of the power mass is then added to assist in ball milling;

5) Low-energy ball milling: The ball milling tank in step 4) is placed into a low-energy ball mill, a ball milling time is set as 1-6 hours, a ball milling speed is set at 256 rpm, an alternating time for clockwise/counterclockwise rotation is set as 6 minutes, and the slurry obtained after ball milling is washed in anhydrous ethyl alcohol;

6) Orientation and forming of a magnetic field: The washed magnetic powder is orientated, cured and formed in a magnetic field after a certain amount of binder is added to obtain high-performance anisotropic MnBi alloy magnets finally.

Further, the non-ionic surfactant in step 4) is polyvinylpyrrolidone (PVP), with an addition accounting for 5-15% of the power mass; a ratio of ball to powder is 10:1.

Further, the ball milling time in step 5) is 1-6 hours, and the ball milling speed is 256 rpm.

Further, the magnitude of the oriented magnetic field in step 6) is 3˜5T.

Compared with the prior art, the present invention has the advantages that:

(1) The non-ionic surfactant polyvinylpyrrolidone added can significantly and effectively reduce the decomposition of the LTP-MnBi phase, and compared with cationic or anionic surfactant, multiple functional groups on the branched chain of the surfactant can protect the LTP-MnBi phase more efficiently, thus reducing the decomposition;

(2) Compared with common high-energy ball milling processes, the technological process of the present invention is simple and easy to operate; it effectively improves the magnetic performance of MnBi and reduces production costs.

### BRIEF DESCRIPTION OF THE DRAWINGS

FIG. 1 shows a magnetic hysteresis loop of MnBi alloy magnets prepared by Embodiment 1.

FIG. 2 shows a magnetic hysteresis loop of MnBi alloy magnets prepared by Comparative Embodiment 1.

FIG. 3 shows a magnetic hysteresis loop of MnBi alloy magnets prepared by Embodiment 2.

FIG. 4 shows a magnetic hysteresis loop of MnBi alloy magnets prepared by Embodiment 3.

### DESCRIPTION OF THE EMBODIMENTS

A further description is made to the present invention in combination with the drawings.

### Embodiment 1

1) Proportioning: Mn and Bi with a purity of over 99.99% were weighed and proportioned according to a nominal composition of Mn₄₅Bi₅₅;

2) Melting: The proportioned raw materials were placed into an electric arc furnace under argon protection to obtain Mn₄₅Bi₅₅ alloy ingots by using an arc-melting method;

3) Coarse crushing: The Mn₄₅Bi₅₅ alloy ingots obtained in step 2) were coarsely crushed and passed through a 100-mesh sieve to obtain coarse powder;

4) Proportioning in a ball milling tank: An appropriate amount of Mn₄₅Bi₅₅ alloy coarse powder obtained in step 3) was put into a ball milling tank together with non-magnetic steel balls, an appropriate amount of ethanol was added as solvent, and polyvinylpyrrolidone (PVP) accounting for 5% of the power mass was then added to assist in ball milling;

5) Low-energy ball milling: The ball milling tank in step 4) was placed into a low-energy ball mill, a ball milling time was set as 1 hour, a ball milling speed was set at 256 rpm, an alternating time for clockwise/counterclockwise rotation was set as 6 minutes, and the slurry obtained was washed in anhydrous ethyl alcohol;

6) Orientation and forming of a magnetic field: The washed magnetic powder was orientated, cured and formed in a 3T magnetic field after a certain amount of binder was added to obtain high-performance anisotropic MnBi alloy magnets finally.

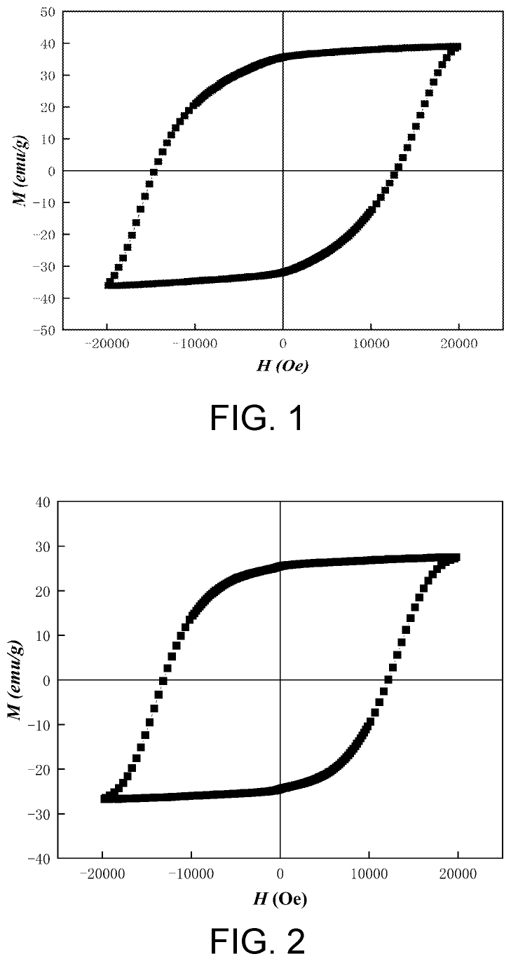

7) The magnetic property was tested by using a vibrating sample magnetometer. The magnetic hysteresis loop is as shown in FIG. 1 and the test results are as shown in Table 1.

Comparative Embodiment 1

1) Proportioning: Mn and Bi alloys with a purity of over 99.99% were weighed and proportioned according to a nominal composition of Mn₄₅Bi₅₅;

2) Melting: The proportioned raw materials were placed into an electric arc furnace under argon protection to obtain Mn₄₅Bi₅₅ alloy ingots by using an arc-melting method;

3) Coarse crushing: The Mn₄₅Bi₅₅ alloy ingots obtained in step 2) were coarsely crushed and passed through a 100-mesh sieve to obtain coarse powder;

4) Proportioning in a ball milling tank: An appropriate amount of Mn₄₅Bi₅₅ alloy coarse powder obtained in step 3) was put into a ball milling tank together with non-magnetic steel balls, with a ratio of ball to powder of 10:1; an appropriate amount of ethanol was added as solvent, and no surfactant was added to assist in ball milling; and the ball milling tank was assembled and placed into a low-energy ball mill;

5) Low-energy ball milling: The ball milling tank in step 4) was placed into a low-energy ball mill, a ball milling time was set as 1 hour, a ball milling speed was set at 256 rpm, an alternating time for clockwise/counterclockwise rotation was set as 6 minutes, and the slurry obtained was washed in anhydrous ethyl alcohol;

6) Orientation and forming in a magnetic field: The washed magnetic powder was orientated, cured and formed in a 3 T magnetic field after a certain amount of binder was added to obtain MnBi alloy magnets finally.

7) The magnetic property was tested by using a vibrating sample magnetometer. The magnetic hysteresis loop is as shown in FIG. 1 and the test results are as shown in Table 1.

### Embodiment 2

1) Proportioning: Mn and Bi with a purity of over 99.99% were weighed and proportioned according to a nominal composition of Mn₅₀Bi₅₀;

2) Melting: The proportioned raw materials were placed into an electric arc furnace under argon protection to obtain Mn₅₀Bi₅₀ alloy ingots by using an arc-melting method;

3) Coarse crushing: The Mn₅₀Bi₅₀ alloy ingots obtained in step 2) were coarsely crushed and passed through a 100-mesh sieve to obtain the coarse powder;

4) Proportioning in a ball milling tank: An appropriate amount of Mn₅₀Bi₅₀ alloy coarse powder obtained in step 3) was put into a ball milling tank together with non-magnetic steel balls, an appropriate amount of ethanol was added as solvent, and polyvinylpyrrolidone (PVP) accounting for 10% of the power mass was then added to assist in ball milling;

5) Low-energy ball milling: The ball milling tank in step 4) was placed into a low-energy ball mill, a ball milling time was set as 3 hours, a ball milling speed was set at 256 rpm, an alternating time for clockwise/counterclockwise rotation was set as 6 minutes, and the slurry obtained was washed in anhydrous ethyl alcohol;

6) Orientation and forming in a magnetic field: The washed magnetic powder was orientated, cured and formed in a 4 T magnetic field after a certain amount of binder was added to obtain high-performance anisotropic MnBi alloy magnets finally.

7) The magnetic property was tested by using a vibrating sample magnetometer. The magnetic hysteresis loop is as shown in FIG. 2 and the test results are as shown in Table 1.

### Embodiment 3

1) Proportioning: Mn and Bi with a purity of over 99.99% were weighed and proportioned according to a nominal composition of Mn₅₅Bi₄₅;

2) Melting: The proportioned raw materials were placed into an electric arc furnace under argon protection to obtain Mn₅₅Bi₄₅ alloy ingots by using an arc-melting method;

3) Coarse crushing: The Mn₅₅Bi₄₅ alloy ingots obtained in step 2) were coarsely crushed and passed through a 100-mesh sieve to obtain coarse powder;

4) Proportioning in a ball milling tank: An appropriate amount of Mn₅₅Bi₄₅ alloy coarse powder obtained in step 3) was put into a ball milling tank together with a non-magnetic steel ball, with a ratio of ball to powder of 10:1; an appropriate amount of ethanol was added as solvent, and polyvinylpyrrolidone (PVP) accounting for 15% of the power mass was then added to assist in ball milling; and the ball milling tank was assembled and placed into a low-energy ball mill;

5) Low-energy ball milling: The ball milling tank in step 4) was placed into a low-energy ball mill, a ball milling time was set as 6 hours, a ball milling speed was set at 256 rpm, an alternating time for clockwise/counterclockwise rotation was set as 6 minutes, and the slurry obtained was washed in anhydrous ethyl alcohol;

6) Orientation and forming in a magnetic field: The washed magnetic powder was orientated, cured and formed in a 5 T magnetic field after a certain amount of binder was added to obtain high-performance anisotropic MnBi alloy magnets finally.

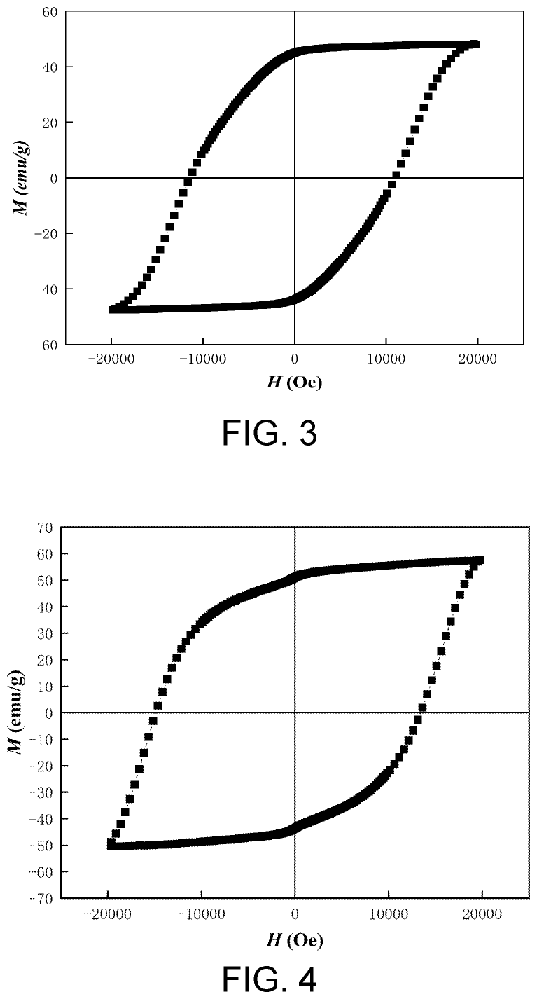

7) The magnetic property was tested by using a vibrating sample magnetometer. The magnetic hysteresis loop is as shown in FIG. 3 and the test results are as shown in Table 1.

TABLE 1

| | | Saturation | Intrinsic |
|---|---|---|---|
| | Type of | Magnetization Mₛ | Coercivity |
| No. | Surfactant | (emu/g) | H_{cj} (kOe) |
| Comparative | No surfactant | 27.85 | 12.6 |
| Embodiment 1 | added | | |
| Embodiment 1 | 5% PVP added | 37.90 | 13.7 |
| Embodiment 2 | 10% PVP added | 48.34 | 11.9 |
| Embodiment 3 | 15% PVP added | 57.50 | 14.1 |

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for preparing high-performance anisotropic rare-earth-free permanent magnets comprises the steps of:
1. proportioning: Mn and Bi alloys with a purity of over 99.99% being weighed and proportioned according to a nominal composition of MnₓBi₁₀₀₋ₓ, wherein 45≤×≤55;
2. melting: the proportioned raw materials being placed into an electric arc furnace under argon protection to obtain MnₓBi₁₀₀₋ₓ, alloy ingots by using an arc-melting method;
3. coarse crushing, wherein the MnₓBi₁₀₀₋ₓ alloy ingots obtained in step 2) being coarsely crushed and passed through a 100-mesh sieve to obtain coarse powder;
4. proportioning in a ball milling tank: an appropriate amount of the MnₓBi₁₀₀₋ₓ, alloy coarse powder obtained in step 3) being put into a ball-milling tank together with non-magnetic steel balls, an appropriate amount of ethanol being added as solvent, and a certain mass of non-ionic surfactant being added;
5. low-energy ball milling: the ball-milling tank in step 4) being placed into a low-energy ball mill, a ball milling time and a ball milling speed being set, an alternating time for clockwise/counterclockwise rotation being set as 6 minutes, and the slurry obtained after ball milling being washed in anhydrous ethyl alcohol;
6. orientation and forming in a magnetic field: the washed magnetic powder being orientated, cured and formed in the magnetic field after a certain amount of binder is added to obtain high-performance anisotropic MnBi alloy magnets finally.

2. The method for preparing the high-performance anisotropic rare-earth-free permanent magnets according to claim 1, wherein:
the non-ionic surfactant in step 4) is polyvinylpyrrolidone (PVP); the certain mass of the non-ionic surfactant is 5-15% of the powder mass; and a ratio of the ball to the powder is 10:1.

3. The method for preparing the high-performance anisotropic rare-earth-free permanent magnets according to claim 1, wherein:
the ball milling time in step 5) is 1-6 hours, and the ball milling speed is 256 rpm.

4. The method for preparing the high-performance anisotropic rare-earth-free permanent magnets according to claim 1, wherein:
the magnitude of the oriented magnetic field in step 6) is 3˜5 T.
